(19) United States
(12) Patent Application Publication
(10) Pub. No.: US 2020/0220231 A1
(43) Pub. Date: Jul. 9, 2020

(54) SPLIT-TYPE EMERGENCY STARTING DEVICE, WITH INTELLIGENT PROTECTION DEVICE, FOR BATTERY PACK

(71) Applicant: SHENZHEN VEESTB TECHNOLOGY CO. LTD, Guangdong (CN)

(72) Inventors: Zhenxiong Peng, Guangdong (CN); Lei Zhang, Guangdong (CN)

(21) Appl. No.: 16/629,927

(22) PCT Filed: Jul. 10, 2018
(86) PCT No.: PCT/CN2018/095055

§ 371 Date: Mar. 23, 2020

(30) Foreign Application Priority Data
Jul. 13, 2017 (CN) 201720850183.5

(51) Int. Cl. H01M 10/48; H02H 3/08; H02H 7/18; H01M 10/04

(52) U.S. Cl. CPC H01M 10/482; H01M 10/0445; H02H 7/18; H02H 3/08

(57) ABSTRACT

Disclosed is a split-type emergency starting device, with an intelligent protection device, for a battery pack, comprising: at least two sets of battery packs; a battery voltage measuring module for detecting a voltage between a positive electrode and a negative electrode of each battery in each battery pack and outputting a corresponding voltage value; a short-circuit protection module for protecting a battery when an output of each battery short-circuits; a first switch module arranged between each battery pack and an external charging input, and a second switch module arranged between each battery pack and a battery external output; and an MCU for receiving the voltage value and respectively outputting a first control signal and a second control signal to the first switch module and the short-circuit protection module according to a relationship between the voltage value and a pre-set voltage value. By means of split-type input and output protection for a battery, when the battery is charging and discharging, each battery pack is in an independent secure state, thereby preventing the use of an entire battery being affected due to one battery pack being damaged; and the structural design is simple and the costs are low.

### TECHNICAL FIELD

The present utility model pertains to the field of emergency start devices, in particular to a split-battery pack emergency start device with an intelligent protection device.

### BACKGROUND

In the prior art, heavy machinery such as automobiles, tank missile transport vehicles, helicopters, and etc. require a large-capacity emergency battery to start in the event of a need for an emergency start. Yet in cases where the emergency battery has a large capacity, if an operation error causes a short circuit in wiring, a built-in power supply in the heavy machinery as well as the emergency battery can be burnt out instantly. At the same time, such an emergency battery has large output power and needs to be replaced frequently to ensure efficient start of the heavy machinery. At present, the security performance of products on the market is not sufficient. Short-circuit connections easily occur during emergency start of heavy machinery, and malfunctions, when they occur on an unspecified part of the emergency battery, cause the entire emergency battery to be scrapped, thereby resulting in relatively high maintenance costs.

Therefore, the prior art has defects that need to be improved upon.

### SUMMARY

The technical problem to be solved by the present utility model is to provide a low-cost split-battery pack emergency start device with an intelligent protection device, which is capable of preventing damage to heavy machinery and an emergency start battery pack in case of short circuits during emergency start of the machinery. The emergency battery pack consists of a plurality of battery packs that are reusable and connected in parallel, and each battery pack is protected by split charge-discharge protection.

The technical solution of the present utility model is as follows: A split-battery pack emergency start device with an intelligent protection device, comprising: a battery voltage measuring module for measuring a voltage between a positive electrode and a negative electrode of each battery in each battery pack and outputting a corresponding voltage value; a short-circuit protection module for protecting a battery in case of a short-circuit in each battery output; a first switch module disposed between each battery pack and an external charging input, the first switch module comprising a number of switch elements corresponding to each battery in each battery pack; a second switch module disposed between each battery pack and an external battery output; and an MCU, the MCU used for receiving a voltage value and respectively outputting a first control signal and a second control signal to the first switch module and the short-circuit protection module according to a relationship between the voltage value and a preset voltage value, and the MCU further controlling an ON-OFF loop between each battery pack and the external charging input, as well as controlling the short-circuit protection module to output a third control signal to the second switch module so as to implement the ON-OFF loop between the battery pack and the external battery output, wherein

a voltage value output terminal of the battery voltage measuring module is connected to a voltage value input terminal of the MCU; a first control signal output terminal of the MCU is connected to a first control signal input terminal of the first switch module, a second control signal output terminal of the MCU is connected to a second control signal input terminal of the short-circuit protection module, and a third control signal output terminal of the short-circuit protection module is connected to a third control signal input terminal of the second switch module.

With the above technical solution incorporated, in the split-battery pack emergency start device with an intelligent protection device, the battery pack consists of a first battery pack, a second battery pack, a third battery pack, a fourth battery pack, and a fifth battery pack connected in parallel.

With the above technical solutions incorporated, in the split-battery pack emergency start device with an intelligent protection device, the battery voltage measuring module comprises a first battery pack voltage measuring module, a second battery pack voltage measuring module, a third battery pack voltage measuring module, a fourth battery pack voltage measuring module, and a fifth battery pack voltage measuring module.

With the above technical solutions incorporated, in the split-battery pack emergency start device with an intelligent protection device, the first battery pack voltage measuring module comprises a first battery pack protecting IC, a first resistor, a second resistor, a third resistor, a fourth resistor, a fifth resistor, a sixth resistor, a first capacitor, a first socket, a first transistor, and a second transistor, wherein

a first output terminal of the first battery pack is electrically connected to a first input terminal of the first socket via the first battery pack protecting IC, a second output terminal of the first battery pack is electrically connected to a second input terminal of the first socket via the first resistor, and the second input terminal of the first socket is respectively grounded via the second resistor and the first capacitor; a first output terminal of the first socket is electrically connected to a base electrode of the first transistor via the third resistor, a collector electrode of the first transistor is electrically connected to a first input terminal of the MCU, an emitter electrode of the first transistor is grounded, and the base electrode of the first transistor is grounded via the fourth resistor; and a second output terminal of the first socket is electrically connected to a base electrode of the second transistor via the fifth resistor, a collector electrode of the second transistor is electrically connected to a second input terminal of the MCU, an emitter electrode of the second transistor is grounded, and the base electrode of the second transistor is grounded via the sixth resistor.

With the above technical solutions incorporated, in the split-battery pack emergency start device with an intelligent protection device, the second battery pack voltage measuring module comprises a second battery pack protecting IC, a seventh resistor, an eighth resistor, a ninth resistor, a tenth resistor, an eleventh resistor, a twelfth resistor, a second capacitor, a second socket, a third transistor, and a fourth transistor, wherein

a first output terminal of the second battery pack is electrically connected to a first input terminal of the second socket via the second battery pack protecting IC, a second output terminal of the second battery pack is electrically connected to a second input terminal of the second socket via the seventh resistor, and the second input terminal of the second socket is respectively grounded via the eighth resistor and the second capacitor; a first output terminal of the second socket is electrically connected to a base electrode of the third transistor via the ninth resistor, a collector electrode of the third transistor is electrically connected to a third input terminal of the MCU, an emitter terminal of the third transistor is grounded, and the base electrode of the third transistor is grounded via the tenth resistor; and a second output terminal of the second socket is electrically connected to a base electrode of the fourth transistor via the eleventh resistor, a collector electrode of the fourth transistor is electrically connected to a fourth input terminal of the MCU, an emitter electrode of the fourth transistor is grounded, and the base electrode of the fourth transistor is grounded via the sixth resistor.

With the above technical solutions incorporated, in the split-battery pack emergency start device with an intelligent protection device, the third battery pack voltage measuring module comprises a third battery pack protecting IC, a thirteenth resistor, a fourteenth resistor, a fifteenth resistor, a sixteenth resistor, a seventeenth resistor, an eighteenth resistor, a third capacitor, a third socket, a fifth transistor, and a sixth transistor, wherein
a first output terminal of the third battery pack is electrically connected to a first input terminal of the third socket via the third battery pack protecting IC, a second output terminal of the third battery pack is electrically connected to a second input terminal of the third socket via the thirteenth resistor, and the second input terminal of the third socket is respectively grounded via the fourteenth resistor and the third capacitor; a first output terminal of the third socket is electrically connected to a base electrode of the fifth transistor via the fifteenth resistor, a collector electrode of the fifth transistor is electrically connected to a fifth input terminal of the MCU, an emitter electrode of the fifth transistor is grounded, and the base electrode of the fifth transistor is grounded via the sixteenth resistor; and a second output terminal of the third socket is electrically connected to a base electrode of the sixth transistor via the seventeenth resistor, a collector electrode of the sixth transistor is electrically connected to a sixth input terminal of the MCU, an emitter electrode of the sixth transistor is grounded, and the base electrode of the sixth transistor is grounded via the eighteenth resistor.

With the above technical solutions incorporated, in the split-battery pack emergency start device with an intelligent protection device, the fourth battery pack voltage measuring module comprises a fourth battery pack protecting IC, a nineteenth resistor, a twentieth resistor, a twenty-first resistor, a twenty-second resistor, a twenty-third resistor, a twenty-fourth resistor, a fourth capacitor, a fourth socket, a seventh transistor, and an eighth transistor, wherein

a first output terminal of the fourth battery pack is electrically connected to a first input terminal of the fourth socket via the fourth battery pack protecting IC, a second output terminal of the fourth battery pack is electrically connected to a second input terminal of the fourth socket via the nineteenth resistor, and the second input terminal of the fourth socket is respectively grounded via the twentieth resistor and the fourth capacitor; a first output terminal of the fourth socket is electrically connected to a base electrode of the seventh transistor via the twenty-first resistor, a collector electrode of the seventh transistor is connected to a seventh input terminal of the MCU, an emitter electrode of the seventh transistor is grounded, and the base electrode of the seventh transistor is grounded via the twenty-second resistor; and a second output terminal of the fourth socket is electrically connected to a base electrode of the eighth transistor via the twenty-third resistor, a collector electrode of the eighth transistor is electrically connected to an eighth input terminal of the MCU, an emitter electrode of the eighth transistor is grounded, and the base electrode of the eighth transistor is grounded via the twenty-fourth resistor.

With the above technical solutions incorporated, in the split-battery pack emergency start device with an intelligent protection device, the fifth battery pack voltage measuring module comprises a fifth battery pack protecting IC, a twenty-fifth resistor, a twenty-sixth resistor, a twenty-seventh resistor, a twenty-eighth resistor, a twenty-ninth resistor, a thirtieth resistor, a fifth capacitor, a fifth socket, a ninth transistor, and a tenth transistor, wherein

a first output terminal of the fifth battery pack is electrically connected to a first input terminal of the fifth socket via the fifth battery pack protecting IC, a second output terminal of the fifth battery pack is electrically connected to a second input terminal of the fifth socket via the twenty-fifth resistor, and the second input terminal of the fifth socket is respectively grounded via the twenty-sixth resistor and the fifth capacitor; a first output terminal of the fifth socket is electrically connected to a base electrode of the ninth transistor via the twenty-seventh resistor, a collector electrode of the ninth transistor is electrically connected to a ninth input terminal of the MCU, an emitter electrode of the ninth transistor is grounded, and the base electrode of the ninth transistor is grounded via the twenty-eighth resistor; and a second output terminal of the fifth socket is electrically connected to a base electrode of the tenth transistor via the twenty-ninth resistor, a collector electrode of the tenth transistor is electrically connected to a tenth input terminal of the MCU, an emitter electrode of the tenth transistor is grounded, and the base electrode of the tenth transistor is grounded via the thirtieth resistor.

With the above technical solutions incorporated, in the split-battery pack emergency start device with an intelligent protection device, the short-circuit protection module comprises a thirty-first resistor, a thirty-second resistor, a thirty-third resistor, a thirty-fourth resistor, a thirty-fifth resistor, a thirty-sixth resistor, an eleventh transistor, a sixth MOS transistor, and an operational amplifier, wherein

a first terminal of the thirty-first resistor is electrically connected to the second control signal output terminal of the MCU, a second terminal thereof is electrically connected to a base electrode of the eleventh transistor, a collector electrode of the eleventh transistor is electrically connected to a first terminal of the thirty-third resistor, an emitter electrode of the eleventh transistor is grounded, the base electrode of the eleventh transistor is grounded via the thirty-second resistor, a second terminal of the thirty-third resistor is electrically connected to a first input terminal of the sixth MOS transistor, the second terminal of the thirty-third resistor is electrically connected to a second input terminal of the sixth MOS transistor via the thirty-fourth resistor, an output terminal of the sixth MOS transistor is electrically connected to a non-inverting input terminal of the operational amplifier via the thirty-fifth resistor, a negative electrode of the external battery output is electrically connected to an inverting input terminal of the operational amplifier via the thirty-sixth resistor, and an output terminal of the operational amplifier is electrically connected to the second switch module.

With the above technical solutions incorporated, in the split-battery pack emergency start device with an intelligent protection device, a driver circuit for driving the second switch module to turn ON or OFF is provided between the short-circuit protection module and the second switch module; the driver circuit comprises a first diode, a second diode, a third diode, a fourth diode, a fifth diode, a first driver IC, a second driver IC, a third driver IC, a fourth driver IC, a fifth driver IC, a thirty-seventh resistor, a thirty-eighth resistor, a thirty-ninth resistor, a fortieth resistor, a forty-first resistor, a forty-second resistor, a forty-third resistor, a forty-fourth resistor, a forty-fifth resistor, and a forty-sixth resistor, wherein

a negative electrode of the first diode is electrically connected to the short-circuit protection module, a positive electrode of the first diode is electrically connected to a first input terminal of the first driver IC, a first output terminal of the first driver IC is electrically connected to the second switch module via the thirty-seventh resistor, and a second output terminal of the first driver IC is electrically connected to the second switch module via the thirty-eighth resistor; a negative electrode of the second diode is electrically connected to the short-circuit protection module, a positive electrode of the second diode is electrically connected to a first input terminal of the second driver IC, a first output terminal of the second driver IC is electrically connected to the second switch module via the thirty-ninth resistor, and a second output terminal of the second driver IC is electrically connected to the second switch module via the fortieth resistor; a negative electrode of the third diode is electrically connected to the short-circuit protection module, a positive electrode of the third diode is electrically connected to a first input terminal of the third driver IC, a first output terminal of the third driver IC is electrically connected to the second switch module via the forty-first resistor, and a second output terminal of the third driver IC is electrically connected to the second switch module via the forty-second resistor; a negative electrode of the fourth diode is electrically connected to the short-circuit protection module, a positive electrode of the fourth diode is electrically connected to a first input terminal of the fourth driver IC, a first output terminal of the fourth driver IC is electrically connected to the second switch module via the forty-third resistor, and a second output terminal of the fourth driver IC is electrically connected to the second switch module via the forty-fourth resistor; and a negative electrode of the fifth diode is electrically connected to the short-circuit protection module, a positive electrode of the fifth diode is electrically connected to a first input terminal of the fifth driver IC, a first output terminal of the fifth driver IC is electrically connected to the second switch module via the forty-fifth resistor, and a second output terminal of the fifth driver IC is electrically connected to the second switch module via the forty-sixth resistor.

By adopting the above technical solutions, the present utility model connects in parallel a plurality of battery packs into an integral whole, and separates the input and output of the battery packs, thereby preventing the malfunction of a single battery pack from affecting the use of the entire battery. At the same time, a short circuit that can burn out the battery and external machinery during external output of a current from the battery can be prevented, thereby achieving a simple structural design and relatively low costs.

### BRIEF DESCRIPTION OF THE DRAWINGS

FIG. 1 is a schematic connection diagram of the present utility model;

FIG. 2 is a schematic circuit diagram of a first battery pack voltage measuring module of the present utility model;

FIG. 3 is a schematic circuit diagram of a second battery pack voltage measuring module of the present utility model;

FIG. 4 is a schematic circuit diagram of a third battery pack voltage measuring module of the present utility model;

FIG. 5 is a schematic circuit diagram of a fourth battery pack voltage measuring module of the present utility model;

FIG. 6 is a schematic circuit diagram of a fifth battery pack voltage measuring module of the present utility model; and

FIG. 7 is a schematic circuit diagram of a short-circuit protection module and a driver circuit of the present utility model.

### DETAILED DESCRIPTION

The following describes the present utility model in detail with reference to the accompanying drawings and specific embodiments.

An embodiment provides a split-battery pack emergency start device with an intelligent protection device, comprising: at least two battery packs; a battery voltage measuring module 4 for measuring a voltage between a positive electrode and a negative electrode of each battery in each battery pack and outputting a corresponding voltage value; a short-circuit protection module 12 for protecting a battery in case of a short-circuit in each battery output; a first switch module 2 disposed between each battery pack and an external charging input 3, the first switch module 2 comprising a number of switch elements corresponding to each battery in each battery pack; a second switch module 10 disposed between each battery pack and an external battery output; and an MCU 8 for receiving a voltage value and respectively outputting a first control signal and a second control signal to the first switch module 2 and the short-circuit protection module 12 according to a relationship between the voltage value and a preset voltage value, the MCU 8 further controlling an ON-OFF loop between each battery pack and the external charging input 3, and controlling the short-circuit protection module 12 to output a third control signal to the second switch module 10 so as to implement the ON-OFF loop between the battery pack and the external battery output.

A voltage value output terminal of the battery voltage measuring module 4 is connected to a voltage value input terminal of the MCU 8; a first control signal output terminal of the MCU 8 is connected to a first control signal input terminal of the first switch module 2; a second control signal output terminal of the MCU 8 is connected to a second control signal input terminal of the short-circuit protection module 12; and a third control signal output terminal of the short-circuit protection module 12 is connected to a third control signal input terminal of the second switch module 10.

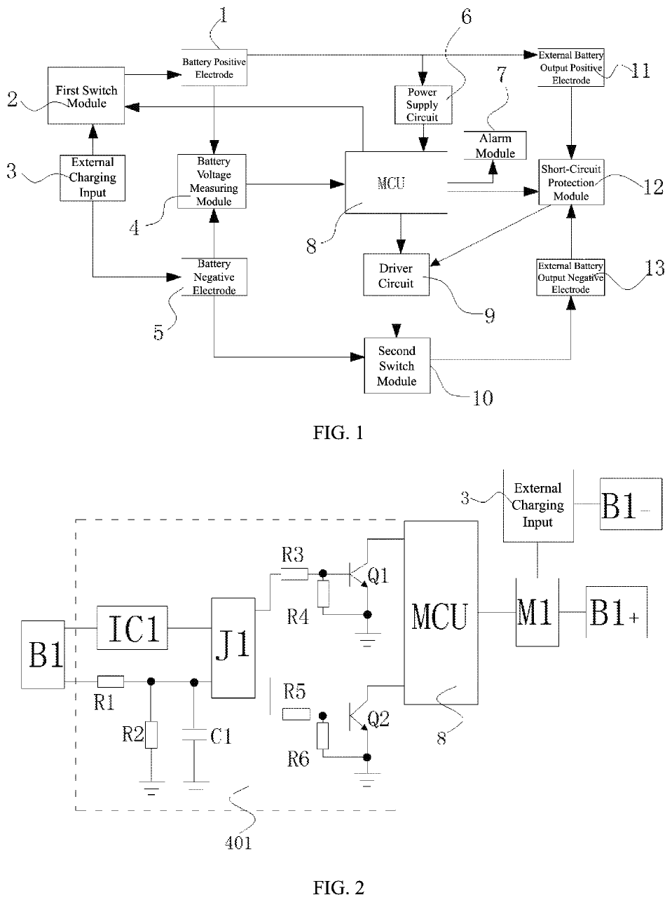

As shown in FIG. 1, the battery in this embodiment is a rechargeable battery that achieves sustainable use of the battery and reduce costs. Since the battery of this embodiment is used for emergency start of heavy machinery that often requires a large current input externally to start by ignition, the battery pack in this embodiment consists of five battery packs connected in parallel to be capable of outputting a large current. Furthermore, each battery pack consists of a plurality of battery cells connected in series. The number of battery cells is not limited and is set only according to the voltage required when external heavy machinery is started. Certainly, the specific number of the battery packs is not limited in this embodiment and is set only according to actual conditions. The battery voltage measuring module 4 is provided between the battery positive electrode 1 and the battery negative electrode 5 for measuring a battery voltage in real time and outputting a corresponding voltage value. The short-circuit protection module 12 is provided between an external battery output positive electrode 11 and an external battery output negative electrode 13, to prevent a battery current from increasing instantly when the battery output is short-circuited to burn out the battery and external connected equipment. In this embodiment, the external battery output positive electrode 11 is a positive clip, and the external battery output negative electrode 13 is a negative clip P−. Certainly, a specific device connected to the external battery output is not specifically limited in this embodiment, and different connected devices are provided only according to actual needs.

The first switch module 2 is disposed between the external charging input 3 and the battery positive electrode 1. When the first switch module 2 is closed, the external charging input charges the battery 3, and when the first switch module 2 is opened, the external charging input 3 stops charging the battery. Certainly, the first switch module 2 may also be disposed between the external charging input 3 and the battery negative electrode 5. This is not specifically limited in this embodiment and is set only according to actual needs. The first switching module 2 comprises five switch elements corresponding one-to-one to the five battery packs in the battery pack, and each switch element controls a battery pack corresponding thereto. During charging of the battery by the external charging input 3, when one or a plurality of battery packs do not need to be charged, a corresponding switch element can be turned OFF, and the single or plurality of battery packs stop charging, while the other battery packs continue charging. That is, mutual interference does not occur among the charging battery packs; the battery packs are independently charged. The second switch module 10 is disposed between the battery negative electrode 5 and the external battery output negative electrode 13. When the battery is required to supply a current to the external equipment, the second switch module 10 is closed; when the battery output is short-circuited or the battery is over-discharged, or the external equipment current flows backwards into the battery, then the second switch module 10 is opened. Certainly, the second switch module 10 may also be disposed between the battery positive electrode 1 and the external battery output positive electrode 11. This is not specifically limited in this embodiment and is set only according to actual needs.

In this embodiment, the MCU 8 is provided for receiving the battery voltage value outputted by the battery voltage measuring module 4. It should be noted that a preset voltage value is set in the MCU 8 according to actual conditions. The MCU 8 also compares the received voltage value with the preset voltage value, and outputs a first control signal and a second control signal according to the relationship between the voltage value and the preset voltage value. When the battery is in a charging state, a power supply circuit 6 supplies an operating voltage to the MCU 8. The MCU 8 determines that the battery is in a normal charging state and outputs a first control signal to the first switch module 2, such that the first switch module 2 is constantly in a closed state. If the battery is in an abnormal charging state, for example, the MCU 8 determines that a battery pack is charging excessively fast and the voltage thereof is excessively high, then the MCU 8 outputs a first control signal to the first switch module 2 to turn OFF a switch element in the first switch module 2 corresponding to the battery pack being charged excessively fast, while the other battery packs continue charging. When the voltages of the five battery packs are the same, then the aforementioned open switch element is closed, and the battery pack that has stopped charging continues to be charged. If the battery in a discharging state, the MCU 8 determines that the battery is in a normal discharge state, and then the MCU 8 outputs a second control signal to the short-circuit protection module 12; the short-circuit protection module 12 outputs a third control signal to a driver circuit 9; and the driver circuit 9 controls the second switch module 10 to be constantly in a closed state. If the MCU 8 determines that the battery is short-circuited or over-discharged or the external equipment current flows backwards into the battery, then the MCU 8 outputs a second control signal to the short-circuit protection module 12; the short-circuit protection module 12 outputs a third control signal to the driver circuit 9; and the driver circuit 9 drives the second switch module 10 to open, so that the battery is disconnected from the external equipment, thereby preventing the battery from being damaged and prolonging the service life of the battery.

Further, the five battery packs in the battery are specifically the following: a first battery pack B1, a second battery pack B2, a third battery pack B3, a fourth battery pack B4, and a fifth battery pack B5 connected in series.

Furthermore, the battery voltage measuring module 4 comprises a first battery pack voltage measuring module 401, a second battery pack voltage measuring module 402, a third battery pack voltage measuring module 403, a fourth battery pack voltage measuring module 404, and a fifth battery pack voltage measuring module 405. Specifically, the first battery pack voltage measuring module 401 corresponds to a first switch element M1, the second battery pack voltage measuring module 402 corresponds to a second switch element M2, the third battery pack voltage measuring module 403 corresponds to a third switch element M3, the fourth battery pack voltage measuring module 404 corresponds to a fourth switch element M4, and the fifth battery pack voltage measuring module 405 corresponds to a fifth switch element M5.

Furthermore, the first battery pack voltage measuring module 401 comprises a first battery pack protecting IC, a first resistor R1, a second resistor R2, a third resistor R3, a fourth resistor R4, a fifth resistor R5, a sixth resistor R6, a first capacitor C1, a first socket J1, a first transistor Q1, and a second transistor Q2. A first output terminal of the first battery pack B1 is electrically connected to a first input terminal of the first socket J1 via the first battery pack protecting IC 1, a second output terminal of the first battery pack B1 is electrically connected to a second input terminal of the first socket J1 via the first resistor R1, and the second input terminal of the first socket J1 is respectively grounded via the second resistor R2 and the first capacitor C1; a first output terminal of the first socket J1 is electrically connected to a base electrode of the first transistor Q1 via the third resistor R3, a collector electrode of the first transistor Q1 is electrically connected to a first input terminal of the MCU 8, an emitter electrode of the first transistor Q1 is grounded, and the base electrode of the first transistor Q1 is grounded via the fourth resistor R4; and a second output terminal of the first socket J1 is electrically connected to a base electrode of the second transistor Q2 via the fifth resistor R5, a collector electrode of the second transistor Q2 is electrically connected to a second input terminal of the MCU 8, an emitter electrode of the second transistor Q2 is grounded, and the base electrode of the second transistor Q2 is grounded via the sixth resistor R6.

As shown in FIG. 2, the principle is as follows: A voltage signal of the first battery pack B1 may be transmitted to the first socket J1 via the first battery pack protecting IC 1, and the voltage signal of the first battery pack B1 may also be transmitted to the first socket J1 via the first resistor R1. The voltage signal of the first battery pack B1 is transferred to the first input terminal of the MCU 8 via the first socket J1, the third resistor R3, and the first transistor Q1, and the voltage signal of the first battery pack B1 may also be transferred to the second input terminal of the MCU 8 via the first socket J1, the fifth resistor R5, and the second transistor Q2. That is, the first battery pack B1 is double-protected. When the MCU 8 determines that the voltage of the first battery pack B1 is in an abnormal state, the MCU 8 immediately outputs a first control signal to the first switch element M1, so that the first switch element M1 is opened. The negative electrode of the first battery pack B1, the external charging input 3, the first switch element M1, and the positive electrode B1+ of the first battery pack form a closed charging loop. Opening the first switch element M1 causes the entire loop to be opened. That is, the external charging input 3 stops charging the first battery pack B1. When the MCU 8 determines that the voltage of the first battery pack B1 is in a normal state, the MCU 8 immediately outputs a first control signal to the first switch element M1, so that the first switch element M1 is closed, to continue charging the first battery pack B1.

Furthermore, the second battery pack voltage measuring module 402 comprises a second battery pack protecting IC 2, a seventh resistor R7, an eighth resistor R8, a ninth resistor R9, a tenth resistor R10, an eleventh resistor R11, a twelfth resistor R12, a second capacitor C2, a second socket J2, a third transistor Q3, and a fourth transistor Q4. A first output terminal of the second battery pack B2 is electrically connected to a first input terminal of the second socket J2 via the second battery pack protecting IC 2, a second output terminal of the second battery pack B2 is electrically connected to a second input terminal of the second socket J2 via the seventh resistor R7, and the second input terminal of the second socket J2 is respectively grounded via the eighth resistor R8 and the second capacitor C2; a first output terminal of the second socket J2 is electrically connected to a base electrode of the third transistor Q3 via the ninth resistor R9, a collector electrode of the third transistor Q3 is electrically connected to a third input terminal of the MCU 8, an emitter terminal of the third transistor Q3 is grounded, and the base electrode of the third transistor Q3 is grounded via the tenth resistor R10; and a second output terminal of the second socket J2 is electrically connected to a base electrode of the fourth transistor Q4 via the eleventh resistor R11, a collector electrode of the fourth transistor Q4 is electrically connected to a fourth input terminal of the MCU 8, an emitter electrode of the fourth transistor Q4 is grounded, and the base electrode of the fourth transistor Q4 is grounded via the sixth resistor R6.

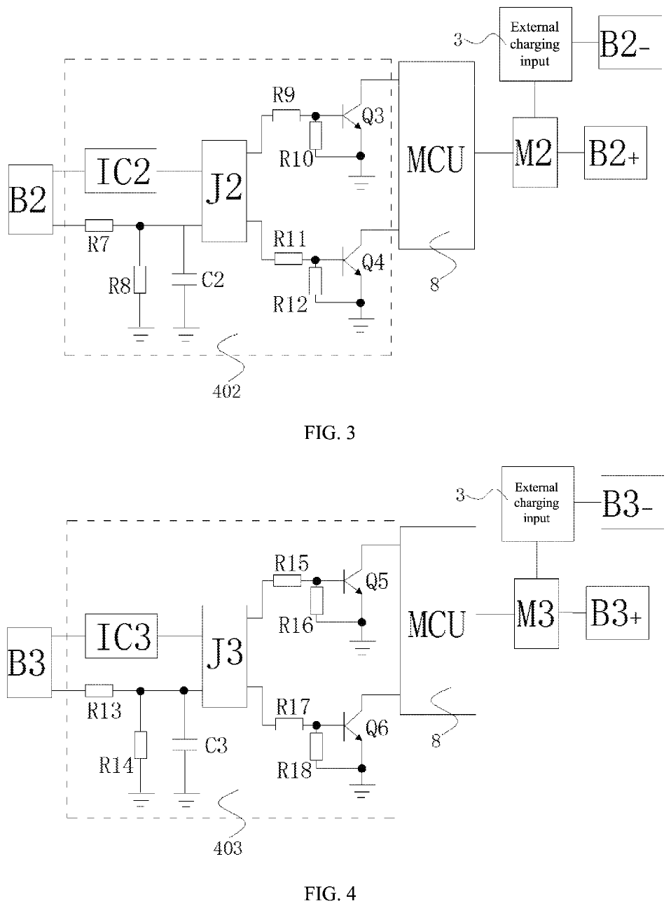

As shown in FIG. 3, the principle is as follows: a voltage signal of the second battery pack B2 may be transmitted to the second socket J2 via the second battery pack protecting IC 2, and the voltage signal of the second battery pack may also be transmitted to the second socket J2 via the seventh resistor R7. The voltage signal of the second battery pack is transferred to the third input terminal of the MCU 8 via the second socket J2, the ninth resistor R9, and the third transistor Q3, and the voltage signal of the second battery pack B2 may also be transferred to the fourth input terminal of the MCU 8 via the second socket J2, the eleventh resistor R11, and the fourth transistor Q4. That is, the second battery pack B2 is double-protected. When the MCU 8 determines that the voltage of the second battery pack B2 is in an abnormal state, the MCU 8 immediately outputs a first control signal to the second switch element M2, so that the second switch element M2 is opened. The negative electrode B2− of the second battery pack, the external charging input 3, the second switch element M2, and the positive electrode B2+ of the second battery pack form a closed charging loop. Opening the second switch element M2 causes the entire loop to be opened. That is, the external charging input 3 stops charging the second battery pack B2. When the MCU 8 determines that the voltage of the second battery pack B2 is in a normal state, the MCU 8 immediately outputs a first control signal to the second switch element M2, so that the second switch element M2 is closed, to continue charging the second battery pack B2.

Furthermore, the third battery pack voltage measuring module 403 comprises a third battery pack protecting IC3, a thirteenth resistor R2, a fourteenth resistor R14, a fifteenth resistor R15, a sixteenth resistor R16, a seventeenth resistor R17, an eighteenth resistor R18, a third capacitor C3, a third socket J3, a fifth transistor Q5, and a sixth transistor Q6. A first output terminal of the third battery pack B3 is electrically connected to a first input terminal of the third socket J3 via the third battery pack protecting IC 3, a second output terminal of the third battery pack B3 is electrically connected to a second input terminal of the third socket J3 via the thirteenth resistor R13, and the second input terminal of the third socket J3 is respectively grounded via the fourteenth resistor R14 and the third capacitor C3; a first output terminal of the third socket J3 is electrically connected to a base electrode of the fifth transistor Q5 via the fifteenth resistor R15, a collector electrode of the fifth transistor Q5 is electrically connected to a fifth input terminal of the MCU 8, an emitter electrode of the fifth transistor Q5 is grounded, and the base electrode of the fifth transistor Q5 is grounded via the sixteenth resistor R16; and a second output terminal of the third socket J3 is electrically connected to a base electrode of the sixth transistor Q6 via the seventeenth resistor R17, a collector electrode of the sixth transistor Q6 is electrically connected to a sixth input terminal of the MCU 8, an emitter electrode of the sixth transistor Q6 is grounded, and the base electrode of the sixth transistor Q6 is grounded via the eighteenth resistor R18.

As shown in FIG. 4, the principle is as follows: A voltage signal of the third battery pack B3 may be transmitted to the third socket J3 via the third battery pack protecting IC3, and the voltage signal of the third battery pack B3 may also be transmitted to the third socket J3 via the thirteenth resistor R13. The voltage signal of the third battery pack B3 is transferred to the fifth input terminal of the MCU 8 via the third socket J3, the fifteenth resistor R15, and the fifth transistor Q5, and the voltage signal of the third battery pack B3 may also be transferred to the sixth input terminal of the MCU 8 via the third socket J3, the seventeenth resistor R17, and the sixth transistor Q6. That is, the third battery pack B3 is double-protected. When the MCU 8 determines that the voltage of the third battery pack B3 is in an abnormal state, the MCU 8 immediately outputs a first control signal to the third switch element M3, so that the third switch element M3 is opened. The negative electrode B3− of the third battery pack, the external charging input 3, the third switch element M3, and the positive electrode B3+ of the third battery pack form a closed charging loop. Opening the third switch element M3 causes the entire loop to be opened. That is, the external charging input 3 stops charging the third battery pack B3. When the MCU 8 determines that the voltage of the third battery pack B3 is in a normal state, the MCU 8 immediately outputs a first control signal to the third switch element M3, so that the third switch element M3 is closed, to continue charging the third battery pack B3.

Furthermore, the fourth battery pack voltage measuring module 404 comprises a fourth battery pack protecting IC 4, a nineteenth resistor R19, a twentieth resistor R20, a twenty-first resistor R21, a twenty-second resistor R22, a twenty-third resistor R23, a twenty-fourth resistor R24, a fourth capacitor C4, a fourth socket J4, a seventh transistor Q7, and an eighth transistor Q8. A first output terminal of the fourth battery pack B4 is electrically connected to a first input terminal of the fourth socket J4 via the fourth battery pack protecting IC 4, a second output terminal of the fourth battery pack B4 is electrically connected to a second input terminal of the fourth socket J4 via the nineteenth resistor R19, and the second input terminal of the fourth socket J4 is respectively grounded via the twentieth resistor R20 and the fourth capacitor C4; a first output terminal of the fourth socket J4 is electrically connected to a base electrode of the seventh transistor Q7 via the twenty-first resistor R21, a collector electrode of the seventh transistor Q7 is connected to a seventh input terminal of the MCU 8, an emitter electrode of the seventh transistor Q7 is grounded, and the base electrode of the seventh transistor Q7 is grounded via the twenty-second resistor R22; and a second output terminal of the fourth socket J4 is electrically connected to a base electrode of the eighth transistor Q8 via the twenty-third resistor R23, a collector electrode of the eighth transistor Q8 is electrically connected to an eighth input terminal of the MCU 8, an emitter electrode of the eighth transistor Q8 is grounded, and the base electrode of the eighth transistor Q8 is grounded via the twenty-fourth resistor R24.

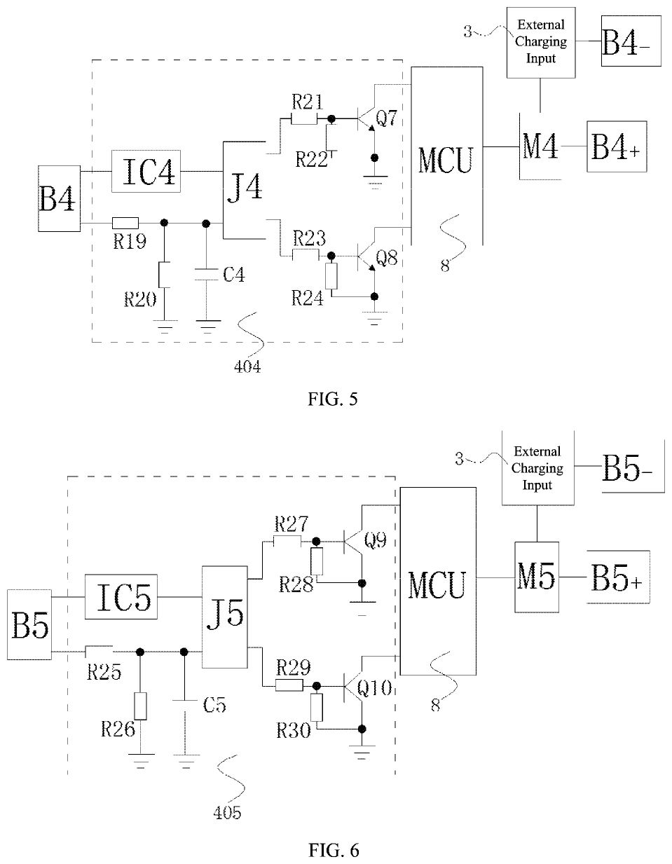

As shown in FIG. 5, the principle is as follows: a voltage signal of the fourth battery pack B4 may be transmitted to the fourth socket J4 via the fourth battery pack protecting IC 4, and the voltage signal of the fourth battery pack B4 may also be transmitted to the fourth socket J4 via the nineteenth resistor R19. The voltage signal of the fourth battery pack B4 is transferred to the seventh input terminal of the MCU 8 via the fourth socket J4, the twenty-first resistor R21, and the seventh transistor Q7; and the voltage signal of the fourth battery pack B4 may also be transferred to the eighth input terminal of the MCU 8 via the fourth socket J4, the twenty-third resistor R23, and the eighth transistor Q8. That is, the fourth battery pack B4 is double-protected. When the MCU 8 determines that the voltage of the fourth battery pack B4 is in an abnormal state, the MCU 8 immediately outputs a first control signal to the fourth switch element M4, so that the fourth switch element M4 is opened. The negative electrode B4− of the fourth battery pack, the external charging input 3, the fourth switch element M4, and the positive electrode B4+ of the fourth battery pack form a closed charging loop. Opening the fourth switch element M4 causes the entire loop to be opened. That is, the external charging input 3 stops charging the fourth battery pack B4. When the MCU 8 determines that the voltage of the fourth battery pack B4 is in a normal state, the MCU 8 immediately outputs a first control signal to the fourth switch element M4, so that the fourth switch element M4 is closed, to continue charging the fourth battery pack B4.

Furthermore, the fifth battery pack voltage measuring module 405 comprises a fifth battery pack protecting IC5, a twenty-fifth resistor R25, a twenty-sixth resistor R26, a twenty-seventh resistor R27, a twenty-eighth resistor R28, a twenty-ninth resistor R29, a thirtieth resistor R30, a fifth capacitor C5, a fifth socket J5, a ninth transistor Q9, and a tenth transistor Q10. A first output terminal of the fifth battery pack B5 is electrically connected to a first input terminal of the fifth socket J5 via the fifth battery pack protecting IC 5, a second output terminal of the fifth battery pack B5 is electrically connected to a second input terminal of the fifth socket J5 via the twenty-fifth resistor R25, and the second input terminal of the fifth socket J5 is respectively grounded via the twenty-sixth resistor R26 and the fifth capacitor C5; a first output terminal of the fifth socket J5 is electrically connected to a base electrode of the ninth transistor Q9 via the twenty-seventh resistor R27, a collector electrode of the ninth transistor Q9 is electrically connected to a ninth input terminal of the MCU 8, an emitter electrode of the ninth transistor Q9 is grounded, and the base electrode of the ninth transistor Q9 is grounded via the twenty-eighth resistor R28; and a second output terminal of the fifth socket J5 is electrically connected to a base electrode of the tenth transistor Q10 via the twenty-ninth resistor R29, a collector electrode of the tenth transistor Q10 is electrically connected to a tenth input terminal of the MCU 8, an emitter electrode of the tenth transistor Q10 is grounded, and the base electrode of the tenth transistor Q10 is grounded via the thirtieth resistor R30.

As shown in FIG. 3, the principle is as follows: A voltage signal of the fifth battery pack B5 may be transmitted to the fifth socket J5 via the fifth battery pack protecting IC 5, and the voltage signal of the fifth battery pack B5 may also be transmitted to the fifth socket J5 via the twenty-fifth resistor R25. The voltage signal of the fifth battery pack B5 is transferred to the ninth input terminal of the MCU 8 via the fifth socket J5, the twenty-seventh resistor R27, and the ninth transistor Q9, and the voltage signal of the fifth battery pack B5 may also be transferred to the tenth input terminal of the MCU 8 via the fifth socket J5, the twenty-ninth resistor R29, and the tenth transistor Q10. That is, the fifth battery pack B5 is double-protected. When the MCU 8 determines that the voltage of the fifth battery pack B5 is in an abnormal state, the MCU 8 immediately outputs a first control signal to the fifth switch element M5, so that the fifth switch element M5 is opened. The negative electrode B5− of the fifth battery pack, the external charging input 3, the fifth switch element M5, and the positive electrode B5+ of the fifth battery pack form a closed charging loop. Opening the fifth switch element M5 causes the entire loop to be opened. That is, the external charging input 3 stops charging the fifth battery pack B5. When the MCU 8 determines that the voltage of the fifth battery pack B5 is in a normal state, the MCU 8 immediately outputs a first control signal to the fifth switch element M5, so that the fifth switch element M5 is closed, to continue charging the fifth battery pack B5.

Furthermore, the short-circuit protection module 12 comprises a thirty-first resistor R31, a thirty-second resistor R32, a thirty-third resistor R33, a thirty-fourth resistor R34, a thirty-fifth resistor R35, a thirty-sixth resistor R36, an eleventh transistor Q11, a sixth MOS transistor M6, and an operational amplifier.

A first terminal of the thirty-first resistor R31 is electrically connected to the second control signal output terminal of the MCU 8, a second terminal thereof is electrically connected to a base electrode of the eleventh transistor Q11, a collector electrode of the eleventh transistor Q11 is electrically connected to a first terminal of the thirty-third resistor R33, an emitter electrode of the eleventh transistor Q11 is grounded, the base electrode of the eleventh transistor Q11 is grounded via the thirty-second resistor R32, a second terminal of the thirty-third resistor R33 is electrically connected to a first input terminal of the sixth MOS transistor, the second terminal of the thirty-third resistor R33 is electrically connected to a second input terminal of the sixth MOS transistor M6 via the thirty-fourth resistor R34, an output terminal of the sixth MOS transistor M6 is electrically connected to a non-inverting input terminal of the operational amplifier via the thirty-fifth resistor R35, a negative electrode 13 of the external battery output is electrically connected to an inverting input terminal of the operational amplifier via the thirty-sixth resistor R36, and an output terminal of the operational amplifier is electrically connected to the second switch module 10.

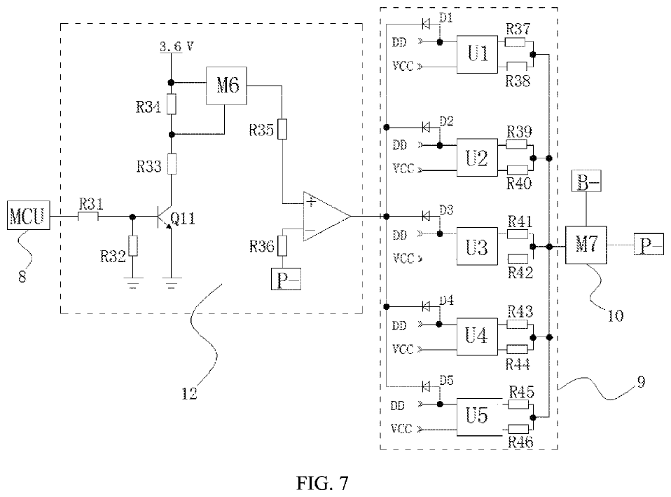

As shown in FIG. 7, the principle is as follows: When the MCU 8 determines that the battery output is short-circuited or the battery is over-discharged, or an external equipment current flows backwards into the battery, then the MCU 8 outputs a second control signal, which is a low-level signal. The low-level signal halts the operation of the eleventh transistor Q11 via the thirty-first resistor R31, and the sixth MOS transistor M6 subsequently halts operation. Hence the non-inverting input terminal of the operational amplifier is at a low level, and the inverting input terminal of the operational amplifier is electrically connected to the battery negative electrode 5 via the thirty-sixth resistor R36. That is, at this time the voltage at the inverting input terminal of the operational amplifier is higher than that of the non-inverting input terminal.

Therefore, the output terminal of the operational amplifier outputs a low level to the second switch module 10. The second switch module is a seventh MOS transistor M7, and the seventh MOS transistor M7 is in a non-operating state without a high-level input, that is, it is in an OFF state. Because the seventh MOS transistor M7 is electrically connected to the battery negative electrode 5 and the clip negative electrode P−, the battery forms a closed loop with the external equipment. Therefore, after the seventh MOS transistor M7 is turned OFF, the battery stops supplying a current to the external equipment to prevent damage to the battery and the external equipment.

Furthermore, a driver circuit 9 for driving the second switch module 10 to turn ON or OFF is provided between the short-circuit protection module 12 and the second switch module 10. The driver circuit 9 comprises a first diode D1, a second diode D2, a third diode D3, a fourth diode D4, a fifth diode D5, a first driver IC U1, a second driver IC U2, a third driver IC U3, a fourth driver IC U4, a fifth driver IC U5, a thirty-seventh resistor R37, a thirty-eighth resistor R38, a thirty-ninth resistor R39, a fortieth resistor R40, a forty-first resistor R41, a forty-second resistor R42, a forty-third resistor R43, a forty-fourth resistor R44, a forty-fifth resistor R45, and a forty-sixth resistor R46.

A negative electrode of the first diode D1 is electrically connected to the short-circuit protection module 12, a positive electrode of the first diode D1 is electrically connected to a first input terminal of the first driver IC, a first output terminal of the first driver IC is electrically connected to the second switch module 10 via the thirty-seventh resistor R37, and a second output terminal of the first driver IC is electrically connected to the second switch module 10 via the thirty-eighth resistor R38; a negative electrode of the second diode D2 is electrically connected to the short-circuit protection module 12, a positive electrode of the second diode D2 is electrically connected to a first input terminal of the second driver IC, a first output terminal of the second driver IC is electrically connected to the second switch module 10 via the thirty-ninth resistor R39, and a second output terminal of the second driver IC is electrically connected to the second switch module 10 via the fortieth resistor R40; a negative electrode of the third diode D3 is electrically connected to the short-circuit protection module 12, a positive electrode of the third diode D3 is electrically connected to a first input terminal of the third driver IC, a first output terminal of the third driver IC is electrically connected to the second switch module 10 via the forty-first resistor R41, and a second output terminal of the third driver IC is electrically connected to the second switch module 10 via the forty-second resistor R42; a negative electrode of the fourth diode D4 is electrically connected to the short-circuit protection module 12, a positive electrode of the fourth diode D4 is electrically connected to a first input terminal of the fourth driver IC, a first output terminal of the fourth driver IC is electrically connected to the second switch module 10 via the forty-third resistor R43, and a second output terminal of the fourth driver IC is electrically connected to the second switch module 10 via the forty-fourth resistor R44; a negative electrode of the fifth diode D5 is electrically connected to the short-circuit protection module 12, a positive electrode of the fifth diode D5 is electrically connected to a first input terminal of the fifth driver IC, a first output terminal of the fifth driver IC is electrically connected to the second switch module 10 via the forty-fifth resistor R45; and a second output terminal of the fifth driver IC is electrically connected to the second switch module 10 via the forty-sixth resistor R46.

As shown in FIG. 7, the principle is as follows: The driver circuit 9 is provided with five driver ICs, and the operating principle of the driver ICs are the same. When one of the driver ICs malfunctions, other non-malfunctioning driver ICs can operate normally, ensuring that the second switch module 10 is always in a normal operable state, so that the battery and the external equipment are always in a secure state. The first driver IC U1 will be described as an example. Under normal conditions, the MCU inputs a high level DD to the first input terminal of the first driver IC and provides an operating voltage VCC to the second input terminal of the first driver IC U1, so that the first driver IC starts to operate and drives the second switch module 10 to be in a closed state. Under abnormal conditions, the short-circuit protection module 12 inputs a low level to the driver circuit 9, and the negative electrode of the first diode is at a low level. The positive electrode of the first diode D1 is electrically connected to the first input terminal of the first driver IC, and the positive electrode thereof is at a high level. When the voltage at the positive electrode of the first diode D1 is higher than the voltage at the negative electrode, the voltage at the first input terminal of the first driver IC U1 is instantly lowered to be the same as the voltage at the negative electrode of the first diode D1. That is, at this time the first input terminal of the first driver IC is at a low level. Therefore, the first input terminal of the first driver IC U1 halts operation immediately due to absence of a high level, and the first output terminal and the second output terminal of the first driver IC output low-level signals. The second switch module 10 is in an OFF state without a high-level input, and the battery stops supplying power to the external equipment to prevent the battery from short-circuiting, over-discharging, and being reverse-charged by the external equipment.

In this embodiment, an alarm module 7 is further provided. The alarm module 7 is a display screen connected to an alarm signal output terminal of the MCU 8. When the battery is in an abnormal state, the MCU 8 outputs an alarm signal to the display screen that immediately shows the battery's cause of malfunction. The status of the battery is displayed in real time on the display screen to improve the battery use security factor.

By adopting the above technical solutions, the present utility model connects in parallel a plurality of battery packs into an integral whole, and separates the input and output of the battery packs, thereby preventing the malfunction of a single battery pack from affecting the use of the entire battery, and a short circuit that burns out the battery and external machinery during external output of a current from the battery can be prevented, thereby achieving a simple structural design and relatively low costs.

The above embodiments are only preferable embodiments of the present utility model, and are not intended to limit the present utility model. Any modification, equivalent replacement, and improvement made within the spirit and principle of the present utility model shall fall within the protection scope of the present utility model.

1. A split-battery pack emergency start device with an intelligent protection device, comprising: at least two battery packs; a battery voltage measuring module for measuring a voltage between a positive electrode and a negative electrode of each battery in each battery pack, and outputting a corresponding voltage value; a short-circuit protection module for protecting a battery in case of a short-circuit in each battery output; a first switch module disposed between each battery pack and an external charging input, the first switch module comprising a number of switch elements corresponding to each battery in each battery pack; a second switch module disposed between each battery pack and an external battery output; and an MCU, the MCU used for receiving a voltage value and respectively outputting a first control signal and a second control signal to the first switch module and the short-circuit protection module according to a relationship between the voltage value and a preset voltage value, and the MCU further controlling an ON-OFF loop between each battery pack and the external charging input, as well as controlling the short-circuit protection module to output a third control signal to the second switch module so as to implement the ON-OFF loop between the battery pack and the external battery output, wherein
a voltage value output terminal of the battery voltage measuring module is connected to a voltage value input terminal of the MCU, a first control signal output terminal of the MCU is connected to a first control signal input terminal of the first switch module, a second control signal output terminal of the MCU is connected to a second control signal input terminal of the short-circuit protection module, and a third control signal output terminal of the short-circuit protection module is connected to a third control signal input terminal of the second switch module.

2. The split-battery pack emergency start device with an intelligent protection device according to claim 1, wherein the battery consists of a first battery pack, a second battery pack, a third battery pack, a fourth battery pack, and a fifth battery pack connected in parallel.

3. The split-battery pack emergency start device with an intelligent protection device according to claim 1 or 2, wherein the battery voltage measuring module comprises a first battery pack voltage measuring module, a second battery pack voltage measuring module, a third battery pack voltage measuring module, a fourth battery pack voltage measuring module, and a fifth battery pack voltage measuring module.

4. The split-battery pack emergency start device with an intelligent protection device according to claim 3, wherein the first battery pack voltage measuring module comprises a first battery pack protecting IC, a first resistor, a second resistor, a third resistor, a fourth resistor, a fifth resistor, a sixth resistor, a first capacitor, a first socket, a first transistor, and a second transistor, wherein
a first output terminal of the first battery pack is electrically connected to a first input terminal of the first socket via the first battery pack protecting IC, a second output terminal of the first battery pack is electrically connected to a second input terminal of the first socket via the first resistor, and the second input terminal of the first socket is respectively grounded via the second resistor and the first capacitor; a first output terminal of the first socket is electrically connected to a base electrode of the first transistor via the third resistor, a collector electrode of the first transistor is electrically connected to a first input terminal of the MCU, an emitter electrode of the first transistor is grounded, and the base electrode of the first transistor is grounded via the fourth resistor; and a second output terminal of the first socket is electrically connected to a base electrode of the second transistor via the fifth resistor, a collector electrode of the second transistor is electrically connected to a second input terminal of the MCU, an emitter electrode of the second transistor is grounded, and the base electrode of the second transistor is grounded via the sixth resistor.

5. The split-battery pack emergency start device with an intelligent protection device according to claim 3, wherein the second battery pack voltage measuring module comprises a second battery pack protecting IC, a seventh resistor, an eighth resistor, a ninth resistor, a tenth resistor, an eleventh resistor, a twelfth resistor, a second capacitor, a second socket, a third transistor, and a fourth transistor, wherein
a first output terminal of the second battery pack is electrically connected to a first input terminal of the second socket via the second battery pack protecting IC, a second output terminal of the second battery pack is electrically connected to a second input terminal of the second socket via the seventh resistor, and the second input terminal of the second socket is respectively grounded via the eighth resistor and the second capacitor; a first output terminal of the second socket is electrically connected to a base electrode of the third transistor via the ninth resistor, a collector electrode of the third transistor is electrically connected to a third input terminal of the MCU, an emitter terminal of the third transistor is grounded, and the base electrode of the third transistor is grounded via the tenth resistor; and a second output terminal of the second socket is electrically connected to a base electrode of the fourth transistor via the eleventh resistor, a collector electrode of the fourth transistor is electrically connected to a fourth input terminal of the MCU, an emitter electrode of the fourth transistor is grounded, and the base electrode of the fourth transistor is grounded via the sixth resistor.

6. The split-battery pack emergency start device with an intelligent protection device according to claim 3, wherein the third battery pack voltage measuring module comprises a third battery pack protecting IC, a thirteenth resistor, a fourteenth resistor, a fifteenth resistor, a sixteenth resistor, a seventeenth resistor, an eighteenth resistor, a third capacitor, a third socket, a fifth transistor, and a sixth transistor, wherein
a first output terminal of the third battery pack is electrically connected to a first input terminal of the third socket via the third battery pack protecting IC, a second output terminal of the third battery pack is electrically connected to a second input terminal of the third socket via the thirteenth resistor, and the second input terminal of the third socket is respectively grounded via the fourteenth resistor and the third capacitor; a first output terminal of the third socket is electrically connected to a base electrode of the fifth transistor via the fifteenth resistor, a collector electrode of the fifth transistor is electrically connected to a fifth input terminal of the MCU, an emitter electrode of the fifth transistor is grounded, and the base electrode of the fifth transistor is grounded via the sixteenth resistor; and a second output terminal of the third socket is electrically connected to a base electrode of the sixth transistor via the seventeenth resistor, a collector electrode of the sixth transistor is electrically connected to a sixth input terminal of the MCU, an emitter electrode of the sixth transistor is grounded, and the base electrode of the sixth transistor is grounded via the eighteenth resistor.

7. The split-battery pack emergency start device with an intelligent protection device according to claim 3, wherein the fourth battery pack voltage measuring module comprises a fourth battery pack protecting IC, a nineteenth resistor, a twentieth resistor, a twenty-first resistor, a twenty-second resistor, a twenty-third resistor, a twenty-fourth resistor, a fourth capacitor, a fourth socket, a seventh transistor, and an eighth transistor, wherein
a first output terminal of the fourth battery pack is electrically connected to a first input terminal of the fourth socket via the fourth battery pack protecting IC, a second output terminal of the fourth battery pack is electrically connected to a second input terminal of the fourth socket via the nineteenth resistor, and the second input terminal of the fourth socket is respectively grounded via the twentieth resistor and the fourth capacitor; a first output terminal of the fourth socket is electrically connected to a base electrode of the seventh transistor via the twenty-first resistor, a collector electrode of the seventh transistor is connected to a seventh input terminal of the MCU, an emitter electrode of the seventh transistor is grounded, and the base electrode of the seventh transistor is grounded via the twenty-second resistor; and a second output terminal of the fourth socket is electrically connected to a base electrode of the eighth transistor via the twenty-third resistor, a collector electrode of the eighth transistor is electrically connected to an eighth input terminal of the MCU, an emitter electrode of the eighth transistor is grounded, and the base electrode of the eighth transistor is grounded via the twenty-fourth resistor.

8. The split-battery pack emergency start device with an intelligent protection device according to claim 3, wherein the fifth battery pack voltage measuring module comprises a fifth battery pack protecting IC, a twenty-fifth resistor, a twenty-sixth resistor, a twenty-seventh resistor, a twenty-eighth resistor, a twenty-ninth resistor, a thirtieth resistor, a fifth capacitor, a fifth socket, a ninth transistor, and a tenth transistor, wherein
a first output terminal of the fifth battery pack is electrically connected to a first input terminal of the fifth socket via the fifth battery pack protecting IC, a second output terminal of the fifth battery pack is electrically connected to a second input terminal of the fifth socket via the twenty-fifth resistor, and the second input terminal of the fifth socket is respectively grounded via the twenty-sixth resistor and the fifth capacitor; a first output terminal of the fifth socket is electrically connected to a base electrode of the ninth transistor via the twenty-seventh resistor, a collector electrode of the ninth transistor is electrically connected to a ninth input terminal of the MCU, an emitter electrode of the ninth transistor is grounded, and the base electrode of the ninth transistor is grounded via the twenty-eighth resistor; and a second output terminal of the fifth socket is electrically connected to a base electrode of the tenth transistor via the twenty-ninth resistor, a collector electrode of the tenth transistor is electrically connected to a tenth input terminal of the MCU, an emitter electrode of the tenth transistor is grounded, and the base electrode of the tenth transistor is grounded via the thirtieth resistor.

9. The split-battery pack emergency start device with an intelligent protection device according to claim 1, wherein the short-circuit protection module comprises a thirty-first resistor, a thirty-second resistor, a thirty-third resistor, a thirty-fourth resistor, a thirty-fifth resistor, a thirty-sixth resistor, an eleventh transistor, a sixth MOS transistor, and an operational amplifier, wherein
a first terminal of the thirty-first resistor is electrically connected to the second control signal output terminal of the MCU, a second terminal thereof is electrically connected to a base electrode of the eleventh transistor, a collector electrode of the eleventh transistor is electrically connected to a first terminal of the thirty-third resistor, an emitter electrode of the eleventh transistor is grounded, the base electrode of the eleventh transistor is grounded via the thirty-second resistor, a second terminal of the thirty-third resistor is electrically connected to a first input terminal of the sixth MOS transistor, the second terminal of the thirty-third resistor is electrically connected to a second input terminal of the sixth MOS transistor via the thirty-fourth resistor, an output terminal of the sixth MOS transistor is electrically connected to a non-inverting input terminal of the operational amplifier via the thirty-fifth resistor, a negative electrode of the external battery output is electrically connected to an inverting input terminal of the operational amplifier via the thirty-sixth resistor, and an output terminal of the operational amplifier is electrically connected to the second switch module.

10. The split-battery pack emergency start device with an intelligent protection device according to claim 1, wherein a driver circuit for driving the second switch module to turn ON or OFF is provided between the short-circuit protection module and the second switch module; the driver circuit comprises a first diode, a second diode, a third diode, a fourth diode, a fifth diode, a first driver IC, a second driver IC, a third driver IC, a fourth driver IC, a fifth driver IC, a thirty-seventh resistor, a thirty-eighth resistor, a thirty-ninth resistor, a fortieth resistor, a forty-first resistor, a forty-second resistor, a forty-third resistor, a forty-fourth resistor, a forty-fifth resistor, and a forty-sixth resistor, wherein
a negative electrode of the first diode is electrically connected to the short-circuit protection module, a positive electrode of the first diode is electrically connected to a first input terminal of the first driver IC, a first output terminal of the first driver IC is electrically connected to the second switch module via the thirty-seventh resistor, and a second output terminal of the first driver IC is electrically connected to the second switch module via the thirty-eighth resistor; a negative electrode of the second diode is electrically connected to the short-circuit protection module, a positive electrode of the second diode is electrically connected to a first input terminal of the second driver IC, a first output terminal of the second driver IC is electrically connected to the second switch module via the thirty-ninth resistor, and a second output terminal of the second driver IC is electrically connected to the second switch module via the fortieth resistor; a negative electrode of the third diode is electrically connected to the short-circuit protection module, a positive electrode of the third diode is electrically connected to a first input terminal of the third driver IC, a first output terminal of the third driver IC is electrically connected to the second switch module via the forty-first resistor, and a second output terminal of the third driver IC is electrically connected to the second switch module via the forty-second resistor; a negative electrode of the fourth diode is electrically connected to the short-circuit protection module, a positive electrode of the fourth diode is electrically connected to a first input terminal of the fourth driver IC, a first output terminal of the fourth driver IC is electrically connected to the second switch module via the forty-third resistor, and a second output terminal of the fourth driver IC is electrically connected to the second switch module via the forty-fourth resistor; and a negative electrode of the fifth diode is electrically connected to the short-circuit protection module, a positive electrode of the fifth diode is electrically connected to a first input terminal of the fifth driver IC, a first output terminal of the fifth driver IC is electrically connected to the second switch module via the forty-fifth resistor, and a second output terminal of the fifth driver IC is electrically connected to the second switch module via the forty-sixth resistor.
